(19) United States
(12) Patent Application Publication
(10) Pub. No.: US 2014/0298848 A1
(43) Pub. Date: Oct. 9, 2014

(54) Composite Freezer for Corpse

(71) Applicant: Huang-Liang Liu, New Taipei City (TW)

(72) Inventor: Huang-Liang Liu, New Taipei City (TW)

(21) Appl. No.: 13/855,767

(22) Filed: Apr. 3, 2013

(51) Int. Cl. A61G 17/00

(52) U.S. Cl. CPC A61G 17/002
USPC 62/344

(57) ABSTRACT

A composite freezer includes a housing (11), a support frame (17) mounted in the housing, a lifting device (16) mounted in the housing to displace the support frame, a water inlet port (115) connected with the housing, a water outlet port (116) connected with the housing, a freezing device (15) mounted in the housing, a heatsink device (18) mounted in the housing, an instrument panel (12) mounted on the housing, a temperature controller (122) mounted on the housing, a humidity controller (123) mounted on the housing, at least one nozzle head (112) mounted on the housing and connected with the water inlet port, and a press button (113) mounted on the nozzle head. Thus, the corpse is defrosted, cleaned, dressed and recovered on the support frame so that all of the necessary procedures for the corpse are accomplished in the housing.

### BACKGROUND OF THE INVENTION

1. Field of the Invention

The present invention relates to a freezer and, more particularly, to a composite freezer for a corpse.

2. Description of the Related Art

A conventional freezer for a corpse comprises a cabinet, a support frame mounted in the cabinet to place the corpse, a door pivotally connected with the cabinet to open or close the cabinet, and an air-conditioner connected with the cabinet to provide an air-conditioning effect to the cabinet. Thus, the cabinet is kept at a lower temperature by operation of the air-conditioner to prevent the corpse from being decayed. The corpse is treated by multiple procedures, including defrosting, cleaning, recovering, dressing and the like, before the funeral. In practice, the operators have to open the door of the cabinet to defrost the corpse. At this time, a cooling fan blows air into the cabinet to provide an air circulation to the cabinet so as to speed the defrosting process. Then, the corpse is moved out of the cabinet and is placed on a moveable bed. Then, the movable bed is moved to a cleaning room to proceed a cleaning process. After the cleaning process is accomplished, the liquid remaining on the corpse is wiped and cleared. Then, the movable bed is moved to a recovery room to proceed a recovering process. Then, the movable bed is moved to a dressing room to proceed a dressing process. However, the corpse is moved and transported many times so as to accomplish all of the works necessary for the corpse, so that it seems that the corpse is not treated in a respectful manner. In addition, the operators have to move and transport the corpse reciprocally from the cabinet to the cleaning room, the recovery room and the dressing room, so that the works are complicated and inconvenient.

### BRIEF SUMMARY OF THE INVENTION

In accordance with the present invention, there is provided a composite freezer, comprising a housing, a support frame movably mounted in the housing, a lifting device mounted in the housing and connected with the support frame to displace the support frame in the housing, a water inlet port connected with the housing, a water outlet port connected with the housing, a freezing device mounted in the housing, a heatsink device mounted in the housing, an instrument panel mounted on the housing, a temperature controller mounted on the housing and connected with the instrument panel, a humidity controller mounted on the housing and connected with the instrument panel, at least one nozzle head mounted on the housing and connected with the water inlet port, and a press button mounted on the nozzle head. The housing has a top provided with an opening and has an interior provided with a receiving chamber. The water inlet port and the water outlet port are located at the bottom of the housing. The temperature controller, the humidity controller, the lifting device, the freezing device and the heatsink device are controlled by the instrument panel. The lifting device lifts or lowers the support frame so as to adjust the height of the support frame in the housing. The lifting device, the freezing device and the heatsink device are connected with the instrument panel.

Preferably, the composite freezer further comprises a plurality of castors mounted on the bottom of the housing.

Preferably, the opening of the housing has a periphery provided with a flange, and a plurality of cold air holes. The flange of the housing has an inner periphery provided with a leakproof strip. The cold air holes of the housing are connected to the freezing device. The cold air holes of the housing are arranged along the periphery of the opening of the housing.

Preferably, the opening of the housing has a periphery provided with at least one thin-shaped light emitting diode (LED).

Preferably, the support frame has a surface provided with a plurality of vent holes each connected to the water outlet port.

Preferably, the composite freezer further comprises a water absorbing cloth combined with the support frame.

Preferably, the composite freezer further comprises a first door pivotally connected with the housing and connected to the receiving chamber of the housing to store the nozzle head, and a second door pivotally connected with the housing and connected to the receiving chamber of the housing. The second door aligns with the lifting device, the freezing device and the heatsink device for maintenance of the lifting device, the freezing device and the heatsink device.

Preferably, the composite freezer further comprises an ultraviolet lamp mounted on the opening of the housing.

Preferably, the lifting device is an oil cylinder or a hydraulically operated cylinder.

Preferably, the freezing device is a compressor or a chilling machine.

Preferably, the composite freezer further comprises a removable lid pivotally connected with the housing and connected to the receiving chamber of the housing. The removable lid aligns with the support frame.

According to the primary advantage of the present invention, the corpse is defrosted, cleaned, dressed and recovered on the support frame so that all of the necessary procedures for the corpse are accomplished completely in the housing, without having to move and transport the corpse, thereby greatly facilitating the operator treating the corpse in a respectful manner.

According to another advantage of the present invention, the wasted water is introduced through the vent holes and the drain channel of the support frame into the drain hose and is drained outward from the housing through the water outlet port so that the corpse will not be affected by the wasted water.

According to a further advantage of the present invention, the liquid drained from the corpse is absorbed by the water absorbing cloth so that the corpse is kept at a dry state.

According to a further advantage of the present invention, the freezing device is operated to produce a cold air which is blown through the cold air holes into the housing to form a cold air curtain in the housing so as to keep the corpse at a lower temperature, thereby preventing the corpse from being decayed or corrupted.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a composite freezer in accordance with the preferred embodiment of the present invention.

FIG. 2 is a partially front cross-sectional view of the composite freezer as shown in FIG. 1.

FIG. 3 is a partially operational view of the composite freezer as shown in FIG. 1.

FIG. 4 is a perspective view of a support frame of the composite freezer as shown in FIG. 1.

FIG. 5 is a schematic operational view of the composite freezer as shown in FIG. 1 in use.

### DETAILED DESCRIPTION OF THE INVENTION

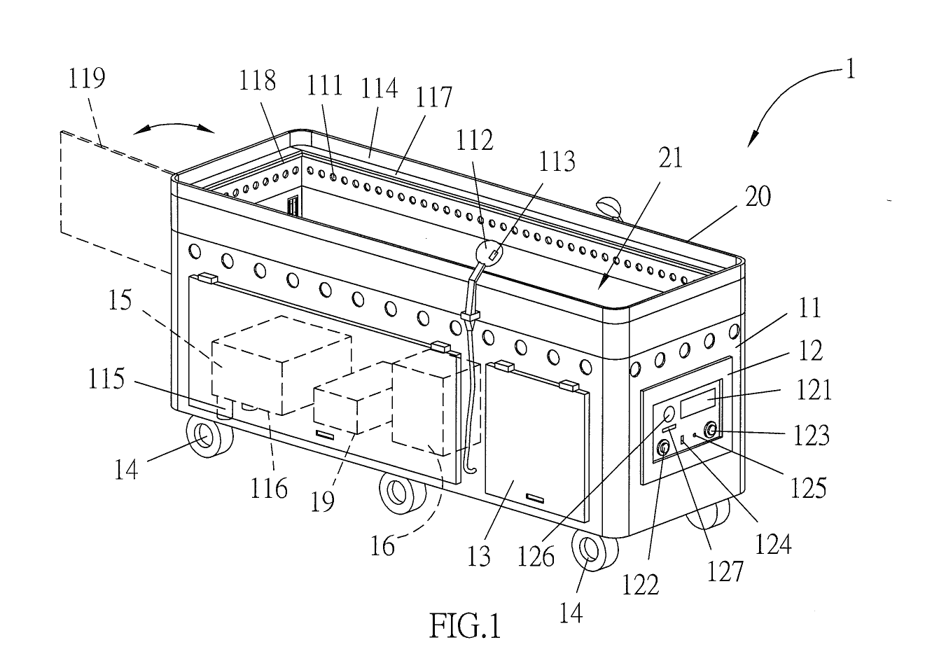

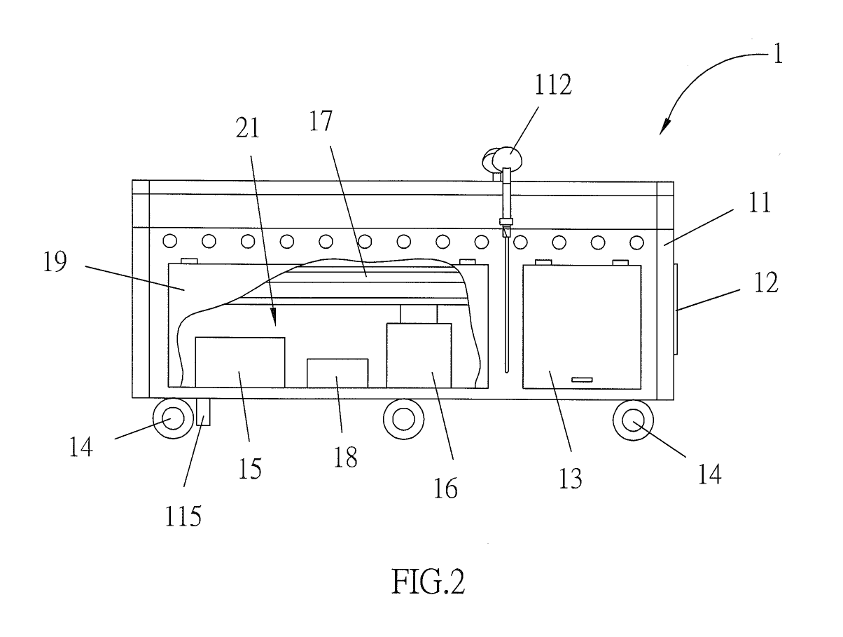

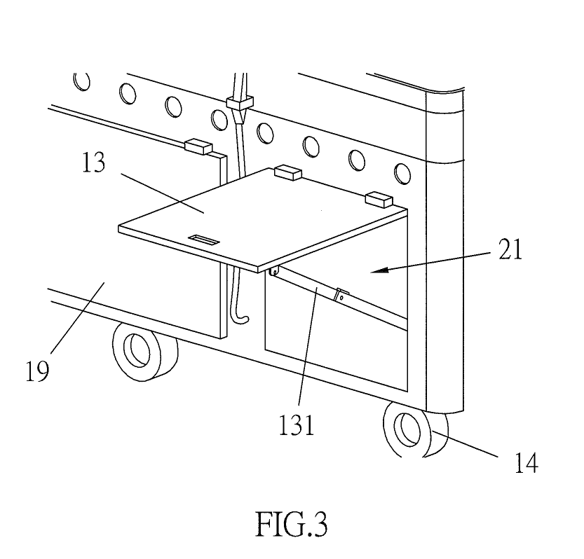

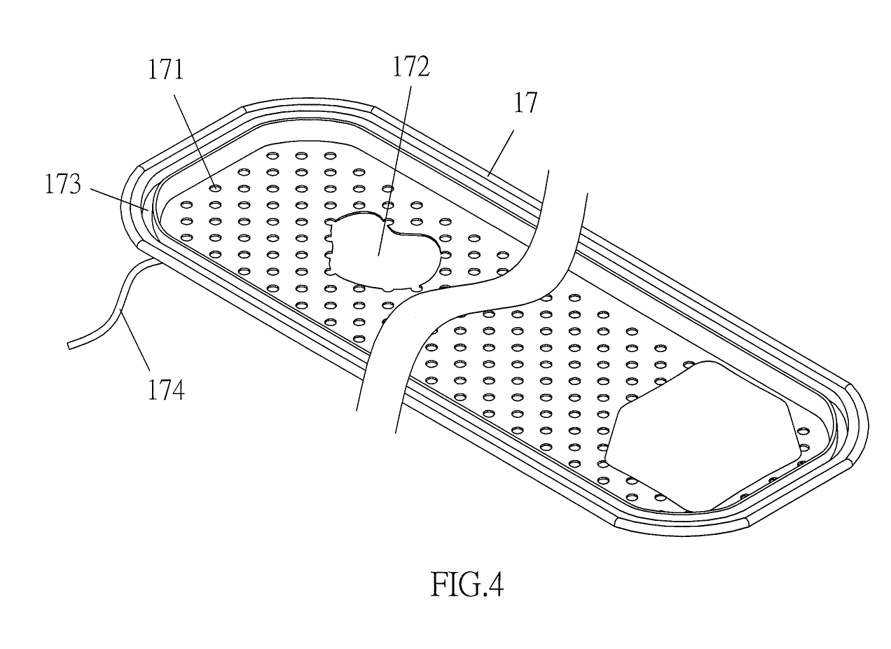

Referring to the drawings and initially to FIGS. 1-4, a composite freezer 1 for a corpse in accordance with the preferred embodiment of the present invention comprises a housing 11, a plurality of castors 14 mounted on the bottom of the housing 11, a support frame 17 movably mounted in the housing 11, a water absorbing cloth 172 combined with the support frame 17, a drain hose 174 connected with the support frame 17, a lifting device 16 mounted in the housing 11 and connected with the support frame 17 to displace the support frame 17 in the housing 11, a water inlet port 115 connected with the housing 11, a water outlet port 116 connected with the housing 11, a freezing device 15 mounted in the housing 11, a heatsink device 18 mounted in the housing 11, an instrument panel 12 mounted on the housing 11, a temperature controller 122 mounted on the housing 11 and connected with the instrument panel 12, a humidity controller 123 mounted on the housing 11 and connected with the instrument panel 12, at least one nozzle head 112 mounted on the housing 11 and connected with the water inlet port 115, and a press button 113 mounted on the nozzle head 112.

The housing 11 has a top provided with an opening 20 and has an interior provided with a receiving chamber 21. The opening 20 of the housing 11 has a periphery provided with a flange 117, at least one thin-shaped light emitting diode (LED) 114, and a plurality of cold air holes 111. The flange 117 of the housing 11 has an inner periphery provided with a leakproof strip 118. The LED 114 of the housing 11 is located above the flange 117 and is controlled by a control switch 127 which is mounted on the instrument panel 12. The cold air holes 111 of the housing 11 are located under the flange 117 and are connected to the freezing device 15. The cold air holes 111 of the housing 11 are arranged along the periphery of the opening 20 of the housing 11. The water inlet port 115 and the water outlet port 116 are located at the bottom of the housing 11. The water outlet port 116 is extended through the housing 11 and is connected to the receiving chamber 21 of the housing 11. In the preferred embodiment of the present invention, the water inlet port 115 is connected with two nozzle heads 112 by a manifold.

The temperature controller 122, the humidity controller 123, the lifting device 16, the freezing device 15 and the heatsink device 18 are controlled by the instrument panel 12. The lifting device 16 lifts or lowers the support frame 17 so as to adjust the height of the support frame 17 in the housing 11. The lifting device 16 is controlled by a control button 124 which is mounted on the instrument panel 12. In the preferred embodiment of the present invention, the lifting device 16 is an oil cylinder or a hydraulically operated cylinder, and the freezing device 15 is a compressor or a chilling machine. The lifting device 16, the freezing device 15 and the heatsink device 18 are mounted in the receiving chamber 21 of the housing 11 and are connected with the instrument panel 12. The freezing device 15 and the heatsink device 18 are controlled by the temperature controller 122.

The support frame 17 is flush with the flange 117 of the housing 11. The support frame 17 is retracted into the receiving chamber 21 of the housing 11 when the lifting device 16 is lowered. The support frame 17 has a surface provided with a plurality of vent holes 171 each connected to the drain hose 174. The support frame 17 has a periphery provided with a drain channel 173 connected to the drain hose 174. The drain hose 174 is connected with the water outlet port 116.

The composite freezer 1 further comprises an ultraviolet lamp mounted on the opening 20 of the housing 11, a display 121 mounted on the instrument panel 12 and connected with the temperature controller 122 and the humidity controller 123 to indicate the temperature of the temperature controller 122 and the humidity of the humidity controller 123, an indicator switch 125 mounted on the instrument panel 12, a timer 126 mounted on the instrument panel 12, a first door 13 pivotally connected with the housing 11 and connected to the receiving chamber 21 of the housing 11 to store the nozzle head 112, a second door 19 pivotally connected with the housing 11 and connected to the receiving chamber 21 of the housing 11, and a removable lid 119 pivotally connected with the housing 11 and connected to the receiving chamber 21 of the housing 11. Each of the first door 13 and the second door 19 is provided with a linkage 131. The second door 19 aligns with the lifting device 16, the freezing device 15 and the heatsink device 18 for maintenance of the lifting device 16, the freezing device 15 and the heatsink device 18. The removable lid 119 aligns with the support frame 17. The ultraviolet lamp of the housing 11 is located above the flange 117.

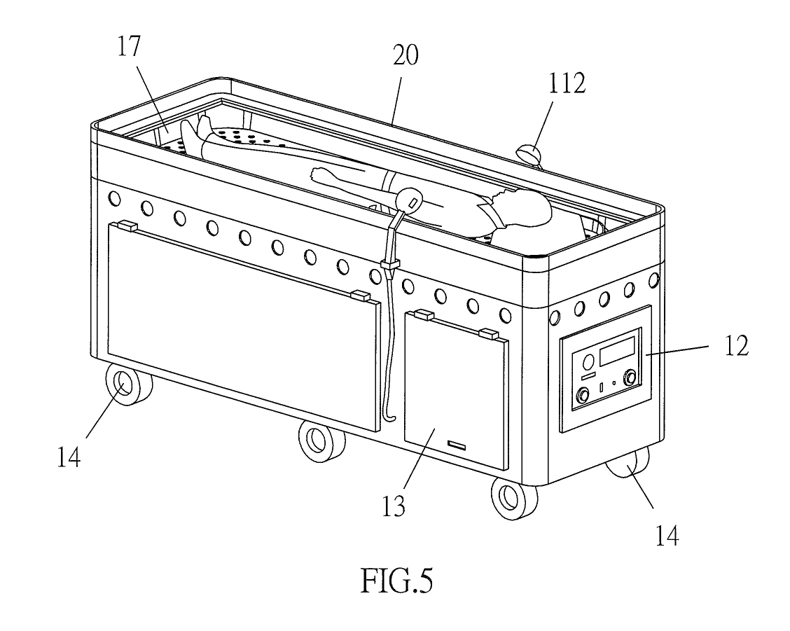

In operation, referring to FIG. 5 with reference to FIGS. 1-4, the lifting device 16 is controlled by the control button 124 to lift the support frame 17, so that the support frame 17 is lifted to the opening 20 of the housing 11. Then, the removable lid 119 is opened to expose the receiving chamber 21 of the housing 11 so that a corpse can be introduced into the receiving chamber 21 of the housing 11 and placed on the support frame 17. In such a manner, the corpse is defrosted in the housing 11 during a period of time. After the defrosting process is accomplished, the housing 11 is moved to a cleaning room by movement of the castors 14. Then, the water inlet port 115 is connected with a water pipe. Then, the first door 13 is opened, and the nozzle head 112 is taken out of the housing 11 and connected with the water inlet port 115. In such a manner, water is injected outward from the nozzle head 112 by pressing the press button 113, so that the operator can clean the corpse by spraying the nozzle head 112. At this time, the wasted water is introduced through the vent holes 171 and the drain channel 173 of the support frame 17 into the drain hose 174 and is drained outward from the housing 11 through the water outlet port 116. After the cleaning process is accomplished, the housing 11 is moved to a dressing room by movement of the castors 14. Then, the corpse is dressed and recovered by a dead makeup artist. At this time, a little amount of water from the corpse is absorbed by the water absorbing cloth 172 during the dressing process. After all of the procedures are accomplished, the lifting device 16 is controlled by the control button 124 to lower the support frame 17, so that the support frame 17 is lowered and retracted into the receiving chamber 21 of the housing 11. Then, the freezing device 15 is operated and controlled by the temperature controller 122 to produce a cold air which is blown through the cold air holes 111 into the housing 11 to form a cold air curtain in the opening 20 of the housing 11 so as to keep the corpse in the housing 11 at a preset temperature.

Accordingly, the corpse is defrosted, cleaned, dressed and recovered on the support frame 17 so that all of the necessary procedures for the corpse are accomplished completely in the housing 11, without having to move and transport the corpse, thereby greatly facilitating the operator treating the corpse in a respectful manner. In addition, the wasted water is introduced through the vent holes 171 and the drain channel 173 of the support frame 17 into the drain hose 174 and is drained outward from the housing 11 through the water outlet port 116 so that the corpse will not be affected by the wasted water. Further, the liquid drained from the corpse is absorbed by the water absorbing cloth 172 so that the corpse is kept at a dry state. Further, the freezing device 15 is operated to produce a cold air which is blown through the cold air holes 111 into the housing 11 to form a cold air curtain in the housing 11 so as to keep the corpse at a lower temperature, thereby preventing the corpse from being decayed or corrupted.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A composite freezer, comprising:
a housing (11);
a support frame (17) movably mounted in the housing;
a lifting device (16) mounted in the housing and connected with the support frame to displace the support frame in the housing;
a water inlet port (115) connected with the housing;
a water outlet port (116) connected with the housing;
a freezing device (15) mounted in the housing;
a heatsink device (18) mounted in the housing;
an instrument panel (12) mounted on the housing;
a temperature controller (122) mounted on the housing and connected with the instrument panel;
a humidity controller (123) mounted on the housing and connected with the instrument panel;
at least one nozzle head (112) mounted on the housing and connected with the water inlet port, and a press button (113) mounted on the nozzle head;
wherein:
the housing has a top provided with an opening (20) and has an interior provided with a receiving chamber (21);
the water inlet port and the water outlet port are located at the bottom of the housing;
the temperature controller, the humidity controller, the lifting device, the freezing device and the heatsink device are controlled by the instrument panel;
the lifting device lifts or lowers the support frame so as to adjust the height of the support frame in the housing; and
the lifting device, the freezing device and the heatsink device are connected with the instrument panel.

2. The composite freezer of claim 1, further comprising:
a plurality of castors mounted on the bottom of the housing.

3. The composite freezer of claim 1, wherein:
the opening of the housing has a periphery provided with a flange, and a plurality of cold air holes;
the flange of the housing has an inner periphery provided with a leakproof strip;
the cold air holes of the housing are connected to the freezing device; and
the cold air holes of the housing are arranged along the periphery of the opening of the housing.

4. The composite freezer of claim 1, wherein the opening of the housing has a periphery provided with at least one thin-shaped light emitting diode (LED).

5. The composite freezer of claim 1, wherein the support frame has a surface provided with a plurality of vent holes each connected to the water outlet port.

6. The composite freezer of claim 1, further comprising:
a water absorbing cloth combined with the support frame.

7. The composite freezer of claim 1, further comprising:
a first door pivotally connected with the housing and connected to the receiving chamber of the housing to store the nozzle head; and
a second door pivotally connected with the housing and connected to the receiving chamber of the housing;
wherein the second door aligns with the lifting device, the freezing device and the heatsink device for maintenance of the lifting device, the freezing device and the heatsink device.

8. The composite freezer of claim 1, further comprising:
an ultraviolet lamp mounted on the opening of the housing.

9. The composite freezer of claim 1, wherein the lifting device is an oil cylinder or a hydraulically operated cylinder.

10. The composite freezer of claim 1, wherein the freezing device is a compressor or a chilling machine.

11. The composite freezer of claim 1, further comprising:
a removable lid pivotally connected with the housing and connected to the receiving chamber of the housing;
wherein the removable lid aligns with the support frame.
